(19) United States
(12) Patent Application Publication
(10) Pub. No.: US 2016/0125303 A1
(43) Pub. Date: May 5, 2016

(54) METHOD AND APPARATUS FOR CALCULATING SMART INDICATOR

(71) Applicant: Xiaomi Inc., Beijing (CN)

(72) Inventors: Yun YANG, Beijing (CN); Yang WANG, Beijing (CN); Feiyun LI, Beijing (CN)

(73) Assignee: Xiaomi Inc., Beijing (CN)

(21) Appl. No.: 14/835,293

(22) Filed: Aug. 25, 2015

Related U.S. Application Data
(63) Continuation of application No. PCT/CN2015/074940, filed on Mar. 24, 2015.

(30) Foreign Application Priority Data
Oct. 31, 2014 (CN) CN201410602700.8

(51) Int. Cl. G06N 7/00

(52) U.S. Cl. CPC G06N 7/00

(57) ABSTRACT

The present disclosure relates to a method and apparatus for calculating a smart indicator. The method includes: acquiring association information of smart indices; calculating corresponding smart indices respectively according to the acquired association information of the smart indices; and obtaining the smart indicator by a weight calculation according to the smart indices and the number of devices. According to the present disclosure, a user may acquire a smartness degree of his or her home, and sense of participation of the user is improved, thereby promoting user's enthusiasm, and thus enhancing home smartness degree.

### CROSS REFERENCE TO RELATED APPLICATIONS

This application is a continuation of International Application No. PCT/CN2015/074940 with an international filing date of Mar. 24, 2015, which is based upon and claims priority to Chinese Patent Application No. 201410602700.8, filed on Oct. 31, 2014, the entire contents of which are incorporated herein by reference.

### TECHNICAL FIELD

The present disclosure relates to the field of smart homes, and more particularly, to a method and apparatus for calculating a smart indicator.

### BACKGROUND

Smart home, based on dwellings, is a network-based smart home control system which integrates an automation control system, a computer network system, and network communication technologies. The smart home improves safety, convenience, comfort, and artistry of homes, and achieves an environmentally-friendly and energy-saving living environment.

In the related art, the smart home is connected to a smart home system via a configured touch screen, speech recognition-based control, wireless remote control or the like, configures household appliances, performs scenario operations, such that a plurality of appliances are linked and the household appliances in the smart home are capable of communicating with each other.

### SUMMARY

The present disclosure provides a method and apparatus for calculating a smart indicator.

According to a first aspect of embodiments of the present disclosure, a method for calculating a smart indicator is provided. In the method, an apparatus acquires association information of smart indices; where the association information includes: usage information of a safety device, login information of a smart home APP, configuration information of a smart scenario, and the number of devices. The apparatus calculates corresponding smart indices respectively according to the acquired association information of the smart indices, where the smart indices include: a safety index, an activity index, and a linkage index. The apparatus then obtains the smart indicator by a weight calculation according to the smart indices and the number of devices.

According to a second aspect of embodiments of the present disclosure, an apparatus for calculating a smart indicator is provided. The apparatus includes circuitry configured to acquire association information of smart indices, where the association information include: usage information of a safety device, login information of a smart home APP, configuration information of a smart scenario, and the number of devices. The apparatus further include circuitry configured to calculate corresponding smart indices respectively according to the association information of the smart indices acquired by the acquiring module; where the smart indices include: a safety index, an activity index, and a linkage index. The apparatus also includes circuitry configured to obtain the smart indicator by a weight calculation according to the smart indices calculated by the first calculating module and the number of devices.

According to a third aspect of embodiments of the present disclosure, an apparatus for calculating a smart indicator is provided. The apparatus includes: a processor; and a memory for storing instructions executable by the processor. The processor is configured to: acquire association information of smart indices; calculate corresponding smart indices respectively according to the acquired association information of the smart indices; and obtain the smart indicator by a weight calculation according to the smart indices and the number of devices.

According to a fourth aspect of embodiments of the present disclosure, a non-transitory computer-readable storage medium is provided. The non-transitory computer-readable storage medium have stored therein instructions that, when executed by one or more processors of an apparatus, cause the apparatus to perform: acquiring association information of smart indices; where the association information include: usage information of a safety device, login information of a smart home APP, configuration information of a smart scenario, and the number of devices; calculating corresponding smart indices respectively according to the acquired association information of the smart indices; the smart indices including: a safety index, an activity index, and a linkage index; and obtaining the smart indicator by a weight calculation according to the smart indices and the number of devices.

It shall be appreciated that the above general description and the detailed description hereinafter are only illustrative, but not for limiting the present disclosure.

### BRIEF DESCRIPTION OF THE DRAWINGS

The accompanying drawings herein, which are incorporated into and constitute a part of the specification, illustrate embodiments consistent with the present disclosure, and together with the description, serve to explain the principles of the present disclosure.

FIG. 1 is a flowchart illustrating a method for calculating a smart indicator according to an exemplary embodiment of the present disclosure;

FIG. 2 is a flowchart illustrating a method for calculating a smart indicator according to another exemplary embodiment of the present disclosure;

FIG. 3 is a schematic diagram illustrating a display interface of a smart indicator according to an exemplary embodiment of the present disclosure;

FIG. 4 is a block diagram illustrating an apparatus for calculating a smart indicator according to an exemplary embodiment of the present disclosure;

FIG. 5 is a block diagram illustrating an apparatus for calculating a smart indicator according to another exemplary embodiment of the present disclosure; and

FIG. 6 is a block diagram illustrating an apparatus for calculating a smart indicator according to an exemplary embodiment of the present disclosure.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the present disclosure. Instead, they are merely examples of apparatuses and methods consistent with aspects related to the present disclosure as recited in the appended claims.

Reference throughout this specification to “one embodiment,” “an embodiment,” “example embodiment,” or the like in the singular or plural means that one or more particular features, structures, or characteristics described in connection with an embodiment is included in at least one embodiment of the present disclosure. Thus, the appearances of the phrases “in one embodiment” or “in an embodiment,” “in an exemplary embodiment,” or the like in the singular or plural in various places throughout this specification are not necessarily all referring to the same embodiment. Furthermore, the particular features, structures, or characteristics may be combined in any suitable manner in one or more embodiments.

The terminology used in the description of the disclosure herein is for the purpose of describing particular examples only and is not intended to be limiting of the disclosure. As used in the description of the disclosure and the appended claims, the singular forms “a,” “an,” and “the” are intended to include the plural forms as well, unless the context clearly indicates otherwise. Also, as used in the description herein and throughout the claims that follow, the meaning of “in” includes “in” and “on” unless the context clearly dictates otherwise. It will also be understood that the term “and/or” as used herein refers to and encompasses any and all possible combinations of one or more of the associated listed items. It will be further understood that the terms “may include,” “including,” “comprises,” and/or “comprising,” when used in this specification, specify the presence of stated features, operations, elements, and/or components, but do not preclude the presence or addition of one or more other features, operations, elements, components, and/or groups thereof

The solutions provided in the embodiments of the present disclosure may achieve the following beneficial effects: Association information of smart indices is acquired, corresponding smart indices are calculated respectively according to the acquired association information, and a smart indicator is obtained by a weight calculation according to the smart indices and the number of devices. As such, a user may acquire a smartness degree of his or her home, and sense of participation of the user is improved, thereby promoting user's enthusiasm, and thus enhancing home smartness degree.

It should be noted that in all formulas containing a logarithm function described in the present disclosure, the base of the logarithm function is a real number whose value is greater than 1 and may be adaptively selected as required, but the base is omitted from expression for sake of clarity and concision. At least in some of the formulas described hereinafter, the base of the logarithm function is “e”, whose value is approximately equal to 2.71828.

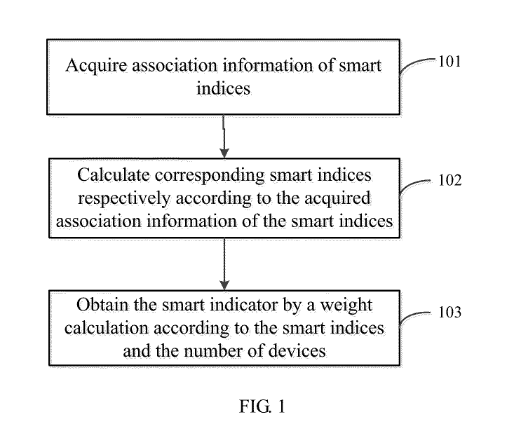

FIG. 1 is a flowchart illustrating a method for calculating a smart indicator according to an exemplary embodiment of the present disclosure. The method for calculating a smart indicator may be implemented in a mobile terminal As illustrated in FIG. 1, the method for calculating a smart indicator includes the following steps.

In step 101, association information of smart indices is acquired. For example, the mobile terminal may acquire the association information of smart indices via a network connection.

The association information includes: usage information of a safety device, login information of a smart home APP, configuration information of a smart scenario, and the number of devices. Here, the smart home APP may be a mobile application program designed to run on smartphones, tablet computers, or other mobile computing devices.

In step 102, corresponding smart indices are calculated respectively according to the acquired association information of the smart indices, where the smart indices include: a safety index, an activity index, and a linkage index.

In step 103, the smart indicator is obtained by a weight calculation according to the smart indices and the number of devices.

In conclusion, with the method for calculating a smart indicator according to the present disclosure, association information of smart indices is acquired, corresponding smart indices are calculated respectively according to the acquired association information, and a smart indicator is obtained by a weight calculation according to the smart indices and the number of devices. As such, a user may acquire a smartness degree of his or her home, and sense of participation of the user is improved, thereby promoting user's enthusiasm, and thus enhancing home smartness degree.

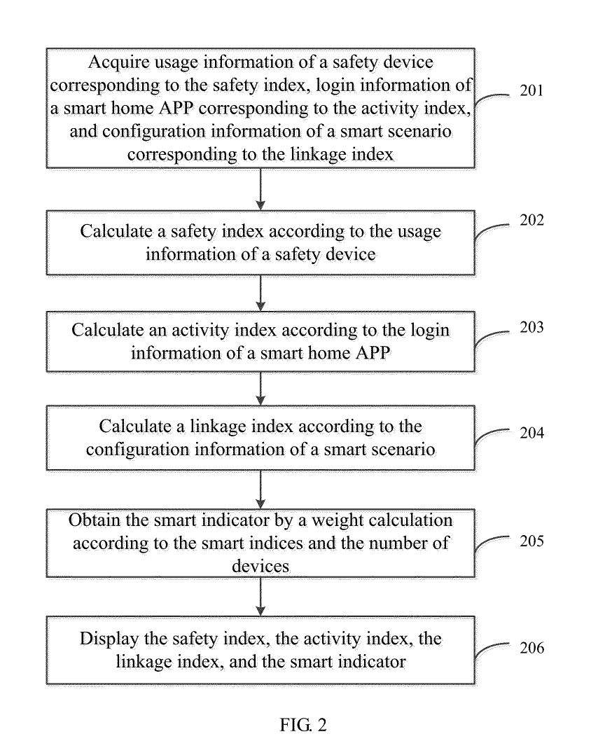

FIG. 2 is a flowchart illustrating a method for calculating a smart indicator according to another exemplary embodiment of the present disclosure. The method for calculating a smart indicator may be implemented in a terminal. As illustrated in FIG. 2, the method for calculating a smart indicator includes the following steps.

In step 201, usage information of a safety device corresponding to the safety index, login information of a smart home APP corresponding to the activity index, and configuration information of a smart scenario corresponding to the linkage index are acquired.

The safety index refers to an indicator at least partially reflecting safety of a smart device. The usage information of a safety device refers to usage details of a device for monitoring latent safety risks in a smart home, and mainly includes: the number of used devices and the types thereof. The acquiring usage information of a safety device corresponding to a safety index includes: acquiring the types of the safety devices, and the number of each type of safety devices. For example, the acquired safety devices include: a safety camera, a door magnetic alarm, an audible and visual alarm, a gas sensor, and a smoke sensor. However, the safety devices are not limited to those listed herein.

The activity index refers to an indicator at least partially reflecting an APP usage activity of a smart device. The login information of a smart home APP refers to a key indicator for calculating retention of a user to a smart home APP, and is mainly determined according to the login times and login duration of the user. The acquiring login information of a smart home APP corresponding to an activity index includes: acquiring an activity cycle T, the login times of the user on each day within the activity cycle T, and a difference of days between the login date and a current date, where the activity cycle is predetermined For example, a predetermined activity cycle is 15 days, the times of logging in to the smart home APP each day within 15 days is acquired. For example, it is Oct. 31, 2014 today, using today as a deadline date for calculation, the times of logging in to the smart home APP each day within the cycle from Oct. 16, 2014 to Oct. 31, 2014 is acquired, and a difference of days between each login date and the deadline date is calculated. It should be noted that, since the greater the difference of days away from the current date is, the less the impact caused to the activity of the user is, therefore, after a subtraction operation is performed between the activity cycle and the difference of days, the less the value obtained is, the less the impact caused to the activity is.

The linkage index refers to an indicator at least partially reflecting an association relation between smart devices. The configuration information of a smart scenario refers to corresponding information between a preset action and performing a corresponding operation. The acquiring configuration information of a smart scenario corresponding to a linkage index includes: acquiring the number of smart scenarios, where the smart scenario refers to a user-predetermined behavior for triggering and performing a corresponding operation after detection or inputting. For example, it is detected whether the user's mobile phone is connected to the WiFi at home, and the home door is automatically opened when it is detected that the mobile phone has been connected to the WiFi at home. Still for example, the user enables a camera for monitoring via a smart home APP on the smart phone, and checks the scene picked up by the home camera.

In step 202, a safety index is calculated according to the usage information of a safety device.

A safety index A₁ is obtained according to a formula

$${A}_{1} = {\sum }_{i = 1}^{n} {a}_{i} * log ( {N}_{i} + 1 )$$

of the safety index A₁.

In the above formula, A₁ indicates a safety index, n indicates the total number of types of the safety devices, i indicates the safety devices of the type i, aᵢ indicates a weight of the safety devices of the type i,

$${\sum }_{i = 1}^{n} {a}_{i} = 100 ,$$

and Nᵢ indicates the number of safety devices of the type i.

For example, there are totally five types of safety devices, and the acquired five types of safety devices and the number of such devices are as follows. First type: two safety cameras; second type: one door magnetic alarm; third type: five audible and visual alarms; fourth type: three gas sensors; and fifth type: two smoke sensors; weights of the five types of safety devices are respectively 30, 20, 20, 15, and 15. The above values are taken into a safety index calculation formula to obtain:

A₁=30*log(2+1)+20*log(1+1)+20*log(5+1)+15*log(3+1)+15*log(2+1)=52;

Where, when the number Nᵢ of safety devices of the type i is greater than a maximum number Pₘₐₓ of the safety devices, a value of Nᵢ is set to Pₘₐₓ.

For example, when Pₘₐₓ=4, the above values are taken into the safety index calculation formula to obtain:

A₁=30*log(2+1)+20*log(1+1)+20*log(4+1)+15*log(3+1)+15*log(2+1)=50;

In addition, it should be noted that, when the obtained safety index is greater than a predetermined maximum threshold, the safety index is set to the maximum threshold.

In step 203, an activity index is calculated according to the login information of a smart home APP.

An activity index A₂ is obtained according to a formula

$${A}_{2} = {\sum }_{j = 1}^{T} log ( {M}_{j} + 1 ) * ( T - {Q}_{j} )$$

of the activity index A₂.

In the above formula, A₂ indicates an activity index, T indicates an activity cycle, Mⱼ indicates login times of a user on the j^{th} day within the activity cycle T, j indicates the j^{th} day within the activity cycle, and Qⱼ indicates a difference of days between the j^{th} day within the activity cycle T and a current date. For example, the activity cycle is five days. Within these five days, on the first day, that is, four days away from the current date, the login times is 15; on the second day, that is, three days away from the current date, the login times is 20; on the third day, that is, two days away from the current date, the login times is 50; on the fourth day, that is, one day away from the current date, the login times is 21; on the fifth day, that is, zero day away from the current date, the login times is 24. The above values are taken into the activity index calculation formula to obtain:

A₂=log(15+1)*(5−4)+log(20+1)*(5−2)+log(21+1)*(5−1)+log(24+1)*(5−0)=9.

In step 204, a linkage index is calculated according to the configuration information of a smart scenario.

A linkage index A₃ is obtained according to a formula A₃=b*log(L+1) of the linkage index A₃.

In the above formula, A₃ indicates a linkage index, b indicates a weight of the smart scenarios, and L indicates the number of smart scenarios.

For example, a weight of the smart scenario is 20, and the number of smart scenarios is 9999. The above values are taken into the linkage index calculation formula to obtain A₃=20*log(9999+1)=60.

It should be noted that steps 202 to 204 are subjected to no definite sequence, and may be performed in any sequence.

In step 205, the smart indicator is obtained by a weight calculation according to the smart indices and the number of devices.

For example, the smart indicator S may be obtained according to a formula S=c₁A₁+c₂A₂+c₃A₃+c₄log(R+1) of the smart indicator S.

In the above formula, S indicates a smart indicator, A₁ indicates a safety index, c₁ indicates a weight of the safety index A₁, A₂ indicates an activity index, c₂ indicates a weight of the activity index A₂, A₃ indicates a linkage index, c₃ indicates a weight of the linkage index A₃, R indicates the number of devices, c₄ indicates a weight of the number R of devices,

$${\sum }_{k = 1}^{4} {c}_{k} = 1 , and k = 1 , 2 , 3 , 4.$$

For example, the safety index A₁=50, the weight of the safety index C₁=0.5, the activity index A₂=9, the weight of the activity index c₂=0.3, the linkage index A₃=60, the weight of the linkage index c₃=0.3, the number of devices R=99, and the weight of the number of devices c₄=0.1. The above values are taken into the smart indicator calculation formula to obtain: S=38.

In step 206, the safety index, the activity index, the linkage index, and the smart indicator are displayed.

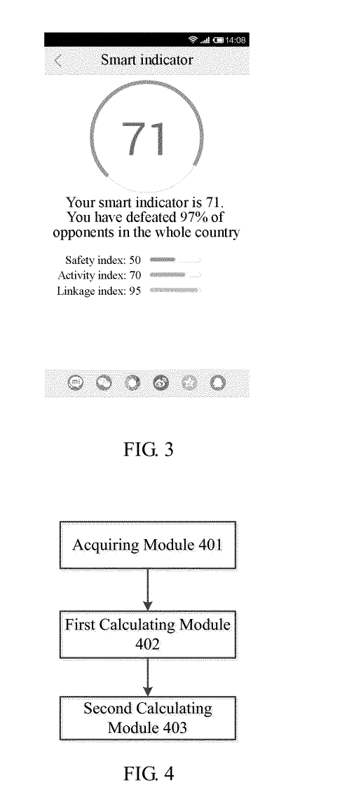

As illustrated in FIG. 3, the smart indicator, the safety index, the activity index, and the linkage index are displayed. For example, a mobile terminal may display the smart indicator, the safety index, and the linkage index in a user interface of a mobile APP. The mobile terminal may also send the indices to other smart devices so that the other smart devices may display at least one of the index.

In addition, with reference to the above embodiments, smart indicators of other users may be acquired from a cloud database, and a current smartness ranking of the user may be calculated, thereby further improving sense of participation of the user.

In conclusion, with the method for calculating a smart indicator according to the present disclosure, usage information of a safety device corresponding to a safety index, login information of a smart home APP corresponding to an activity index, and configuration information of a smart scenario corresponding to a linkage index are acquired, a safety index is calculated according to the usage information of a safety device, an activity index is calculated according to the login information of a smart home APP, a linkage index is calculated according to the configuration information of a smart scenario, and a smart indicator is obtained by a weight calculation according to the smart indicator and the number of devices. As such, a user may acquire a smartness degree of his or her home, and sense of participation of the user is improved, thereby promoting user's enthusiasm, and thus enhancing home smartness degree.

FIG. 4 is a block diagram illustrating an apparatus for calculating a smart indicator according to an exemplary embodiment of the present disclosure. As illustrated in FIG. 4, the apparatus may be a smart device that includes:

an acquiring module 401, configured to acquire association information of smart indices; the association information including: usage information of a safety device, login information of a smart home APP, configuration information of a smart scenario, and the number of devices;

a first calculating module 402, configured to calculate corresponding smart indices respectively according to the association information of the smart indices acquired by the acquiring module. The smart indices may include: a safety index, an activity index, and a linkage index; and

a second calculating module 403, configured to obtain the smart indicator by a weight calculation according to the smart indices calculated by the first calculating module and the number of devices.

The acquiring module 401 is configured to acquire usage information of a safety device corresponding to the safety index, login information of a smart home APP corresponding to the activity index, and configuration information of a smart scenario corresponding to the linkage index; and the first calculating module 402 is configured to calculate a safety index according to the usage information of a safety device, calculate an activity index according to the login information of a smart home APP, and calculate a linkage index according to the configuration information of a smart scenario.

In the calculation of a safety index, the acquiring module 401 is specifically configured to acquire the total number n of types of safety devices corresponding to a safety index A₁, and the number Nᵢ of safety devices of a corresponding type i; and the first calculating module 402 is specifically configured to obtain the safety index A₁ according to a formula

$${A}_{1} = {\sum }_{i = 1}^{n} {a}_{i} * log ( {N}_{i} + 1 )$$

of the safety index A₁. In the formula, A₁ indicates a safety index, n indicates the total number of types of the safety devices, i indicates the safety devices of the type i, aᵢ indicates a weight of the safety devices of the type i,

$${\sum }_{i = 1}^{n} {a}_{i} = 100 ,$$

and Nᵢ indicates the number of safety devices of the type i.

When the number Nᵢ of safety devices of the type i is greater than a maximum number Pₘₐₓ of the safety devices, a value of Nᵢ is set to Pₘₐₓ.

In the calculation of an activity index, the acquiring module 401 is specifically configured to acquire an activity cycle T corresponding to an activity index A₂, and login times Mⱼ of a user on the j^{th} day within the activity cycle T, and calculate a difference Qⱼ of days between the j^{th} day and a current date; and the first calculating module 402 is specifically configured to obtain the activity index A₂ according to a formula

$${A}_{2} = {\sum }_{j = 1}^{T} log ( {M}_{j} + 1 ) * ( T - {Q}_{j} )$$

of the activity index A₂. In the formula, A₂ indicates an activity index, T indicates an activity cycle, Mⱼ indicates login times of a user on the j^{th} day within the activity cycle T, j indicates the j^{th} day within the activity cycle, and Qⱼ indicates a difference of days between the j^{th} day within the activity cycle T and a current date.

In the calculation of a linkage index, the acquiring module 401 is specifically configured to acquire the number L of smart scenarios corresponding to a linkage index A₃; and the first calculating module 402 is specifically configured to obtain the linkage index A₃ according to a formula A₃=b*log(L+1) of the linkage index A₃. In the formula, A₃ indicates a linkage index, b indicates a weight of the smart scenarios, and L indicates the number of smart scenarios.

The second calculating module 403 is configured to obtain the smart indicator S according to a formula S=c₁A₁+C₂A₂+c₃A₃+c₄log(R+1) of the smart indicator S. In the formula, S indicates a smart indicator, A₁ indicates a safety index, c₁ indicates a weight of the safety index A₁, A₂ indicates an activity index, c₂ indicates a weight of the activity index A₂, A₃ indicates a linkage index, c₃ indicates a weight of the linkage index A₃, R indicates the number of devices, c₄ indicates a weight of the number R of devices,

$${\sum }_{k = 1}^{4} {c}_{k} = 1 , and k = 1 , 2 , 3 , 4.$$

With the apparatus for calculating a smart indicator according to the present disclosure, association information of smart indices is acquired, corresponding smart indices are calculated respectively according to the acquired association information, and a smart indicator is obtained by a weight calculation according to the smart indices and the number of devices. As such, a user may acquire a smartness degree of his or her home, and sense of participation of the user is improved, thereby promoting user's enthusiasm, and thus enhancing home smartness degree.

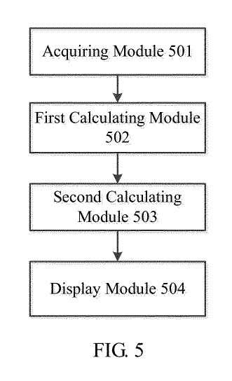

With reference to the above apparatus, FIG. 5 is a block diagram illustrating an apparatus for calculating a smart indicator according to an exemplary embodiment of the present disclosure. As illustrated in FIG. 5, the apparatus may be a smart device that includes:

an acquiring module 501, configured to acquire association information of smart indices; the association information including: usage information of a safety device, login information of a smart home APP, configuration information of a smart scenario, and the number of devices;

a first calculating module 502, configured to calculate corresponding smart indices respectively according to the association information of the smart indices acquired by the acquiring module; the smart indices including: a safety index, an activity index, and a linkage index;

a second calculating module 503, configured to obtain the smart indicator by a weight calculation according to the smart indices calculated by the first calculating module and the number of devices; and

a display module 504, configured to display the safety index, the activity index, the linkage index, and the smart indicator.

With the apparatus for calculating a smart indicator according to the present disclosure, association information of smart indices is acquired, corresponding smart indices are calculated respectively according to the acquired association information, a smart indicator is obtained by a weight calculation according to the smart indices and the number of devices, and the safety index, the activity index, the linkage index, and the smart indicator are displayed. As such, a user may acquire a smartness degree of his or her home, and sense of participation of the user is improved, thereby promoting user's enthusiasm, and thus enhancing home smartness degree.

With respect to the apparatuses in the above embodiments, the specific implementations of operations executed by various modules thereof have been described in detail in the embodiments illustrating the methods, which are not described herein any further.

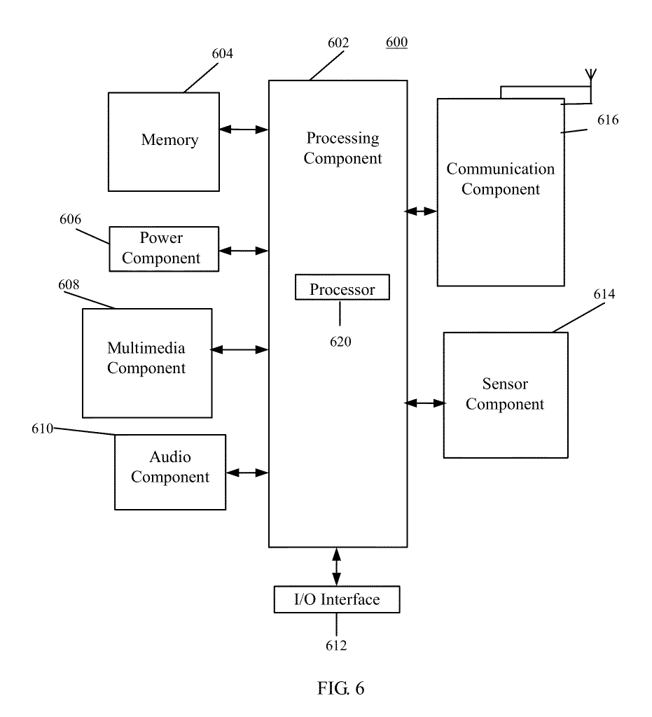

FIG. 6 is a block diagram illustrating an apparatus 600 for calculating a smart indicator according to an exemplary embodiment of the present disclosure. For example, the apparatus 600 may be a mobile phone, a computer, a digital broadcast terminal, a messaging device, a gaming console, a tablet, a medical device, an exercise equipment, a personal digital assistant, a smart router, and the like.

Referring to FIG. 6, the apparatus 600 may include one or more of the following components: a processing component 602, a memory 604, a power component 606, a multimedia component 608, an audio component 610, an input/output (I/O) interface 612, a sensor component 614, and a communication component 616.

The processing component 602 typically controls overall operations of the apparatus 600, such as the operations associated with display, telephone calls, data communications, camera operations, and recording operations. The processing component 602 may include one or more processors 618 to execute instructions to perform all or a part of the steps in the above-described methods. In addition, the processing component 602 may include one or more modules which facilitate the interaction between the processing component 602 and other components. For example, the processing component 602 may include a multimedia module to facilitate the interaction between the multimedia component 608 and the processing component 602.

The memory 604 is configured to store various types of data to support the operations of the apparatus 600. Examples of such data include instructions for any application or method operated on the apparatus 600, contact data, phonebook data, messages, pictures, videos, and the like. The memory 604 may be implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 606 provides power to various components of the apparatus 600. The power component 606 may include a power management system, one or more power supplies, and other components associated with the generation, management, and distribution of power in the apparatus 600.

The multimedia component 608 includes a screen providing an output interface between the apparatus 600 and the user. In some embodiments, the screen may include a liquid crystal display (LCD) and a touch panel (TP). If the screen includes the touch panel, the screen may be implemented as a touch screen to receive input signals from the user. The touch panel includes one or more touch sensors to sense touches, swipes, and gestures on the touch panel. The touch sensors may not only sense a boundary of a touch or swipe action, but also sense a period of time and a pressure associated with the touch or swipe action. In some embodiments, the multimedia component 608 includes a front camera and/or a rear camera. The front camera and/or the rear camera may receive external multimedia data while the apparatus 600 is in an operation mode, such as a photographing mode or a video mode. Each of the front camera and the rear camera may be a fixed optical lens system or have focus and optical zoom capability.

The audio component 610 is configured to output and/or input audio signals. For example, the audio component 610 includes a microphone (MIC) configured to receive an external audio signal when the apparatus 600 is in an operation mode, such as a call mode, a recording mode, or a voice recognition mode. The received audio signal may be further stored in the memory 604 or transmitted via the communication component 616. In some embodiments, the audio component 610 further includes a speaker to output audio signals.

The I/O interface 612 provides an interface between the processing component 602 and a peripheral interface module, such as a keyboard, a click wheel, a button, or the like. The buttons may include, but are not limited to, a home button, a volume button, a starting button, and a locking button.

The sensor component 614 includes one or more sensors to provide status assessments of various aspects of the apparatus 600. For example, the sensor component 614 may detect an open/closed status of the apparatus 600, relative positioning of components, e.g., the display and the keypad, of the apparatus 600, a change in position of the apparatus 600 or a component of the apparatus 600, a presence or absence of user contact with the apparatus 600, an orientation or an acceleration/deceleration of the apparatus 600, and a change in temperature of the apparatus 600. The sensor component 614 may include a proximity sensor configured to detect the presence of nearby objects without any physical contact. The sensor component 614 may also include a light sensor, such as a CMOS or CCD image sensor, for use in imaging applications. In some embodiments, the sensor component 614 may also include an accelerometer sensor, a gyroscope sensor, a magnetic sensor, a pressure sensor, or a temperature sensor.

The communication component 616 is configured to facilitate communications, wired or wirelessly, between the apparatus 600 and other devices. The apparatus 600 may access a wireless network based on a communication standard, such as WiFi, 2G, or 3G, or a combination thereof In one exemplary embodiment, the communication component 616 receives a broadcast signal or broadcast associated information from an external broadcast management system via a broadcast channel. In one exemplary embodiment, the communication component 816 further includes a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, and other technologies.

In exemplary embodiments, the apparatus 600 may be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing the above-described methods. As used herein, the term “module” or “unit” may refer to, be part of, or include an Application Specific Integrated Circuit (ASIC); a circuitry, an electronic circuit; a combinational logic circuit; a field programmable gate array (FPGA); a processor (shared, dedicated, or group) that executes code; other suitable hardware components that provide the described functionality; or a combination of some or all of the above, such as in a system-on-chip. The term module or unit may include memory (shared, dedicated, or group) that stores code executed by the processor.

In exemplary embodiments, there is also provided a non-transitory computer-readable storage medium including instructions, such as included in the memory 604, executable by the processor 618 in the apparatus 600, for performing the above-described methods. For example, the non-transitory computer-readable storage medium may be a ROM, a random access memory (RAM), a compact disc read-only memory (CD-ROM), a magnetic tape, a floppy disc, an optical data storage device, or the like.

Other embodiments of the present disclosure will be apparent to those skilled in the art from consideration of the specification and practice disclosed herein. This application is intended to cover any variations, uses, or adaptations of the present disclosure following the general principles thereof and including such departures from the present disclosure as coming within common knowledge or customary technical means in the art. It is intended that the specification and embodiments be considered as exemplary only, with a true scope and spirit of the present disclosure being indicated by the appended claims. The different exemplary embodiments in the disclosure may be combined to create new embodiment without undue experiments by a person having ordinary skill in the art.

It will be appreciated that the present disclosure is not limited to the exact construction that has been described above and illustrated in the accompanying drawings, and that various modifications and changes can be made without departing from the scope thereof. The scope of the present disclosure is only defined by the appended claims.

What is claimed is:

1. A method for calculating a smart indicator, comprising:
acquiring association information of smart indices; the association information comprising: usage information of a safety device, login information of a smart home APP, configuration information of a smart scenario, and a number of devices;
calculating corresponding smart indices respectively according to the acquired association information of the smart indices; the smart indices comprising: a safety index, an activity index, and a linkage index; and
obtaining the smart indicator by a weight calculation according to the smart indices and the number of devices.

2. The method according to claim 1, wherein the acquiring association information of smart indices comprises:
acquiring usage information of a safety device corresponding to the safety index, login information of a smart home APP corresponding to the activity index, and configuration information of a smart scenario corresponding to the linkage index; and
the calculating corresponding smart indices respectively according to the acquired association information of the smart indices comprises:
calculating a safety index according to the usage information of a safety device, calculating an activity index according to the login information of a smart home APP, and calculating a linkage index according to the configuration information of a smart scenario.

3. The method according to claim 2, wherein the acquiring usage information of a safety device corresponding to the safety index comprises:
acquiring a total number n of types of safety devices corresponding to a safety index A₁, and the number Nᵢ of safety devices of a corresponding type i; and
the calculating a safety index according to the usage information of a safety device comprises:
obtaining the safety index A₁ according to a formula
$${A}_{1} = {\sum }_{i = 1}^{n} {a}_{i} * log ( {N}_{i} + 1 )$$
of the safety index A₁; wherein in the formula, A₁ indicates a safety index, n indicates the total number of types of the safety devices, i indicates the safety devices of the type i, aᵢ indicates a weight of the safety devices of the type i,
$${\sum }_{i = 1}^{n} {a}_{i} = 100 ,$$
and Nᵢ indicates the number of safety devices of the type i.

4. The method according to claim 3, wherein when the number Nᵢ of safety devices of the type i is greater than a maximum number pₘₐₓ of the safety devices, a value of Nᵢ is set to Pₘₐₓ.

5. The method according to claim 2, wherein the acquiring login information of a smart home APP corresponding to the activity index comprises:
acquiring an activity cycle T corresponding to an activity index A₂, and login times Mⱼ of a user on the j^{th} day within the activity cycle T, and calculating a difference Qⱼ of days between the j^{th} day and a current date; and
the calculating an activity index according to the login information of a smart home APP comprises:
obtaining the activity index A₂ according to a formula
$${A}_{2} = {\sum }_{j = 1}^{T} log ( {M}_{j} + 1 ) * ( T - {Q}_{j} )$$
of the activity index A₂; wherein in the formula, A₂ indicates an activity index, T indicates an activity cycle, Mⱼ indicates login times of a user on the j^{th} day within the activity cycle T, j indicates the j^{th} day within the activity cycle, and Qⱼ indicates a difference of days between the j^{th} day within the activity cycle T and a current date.

6. The method according to claim 2, wherein the acquiring configuration information of a smart scenario corresponding to the linkage index comprises:
acquiring the number L of smart scenarios corresponding to a linkage index A₃; and
the calculating a linkage index according to the configuration information of a smart scenario comprises:
obtaining the linkage index A₃ according to a formula A₃=b*log(L+1) of the linkage index A₃; wherein in the formula, A₃ indicates a linkage index, b indicates a weight of the smart scenarios, and L indicates the number of smart scenarios.

7. The method according to claim 1, wherein the obtaining the smart indicator by a weight calculation according to the smart indices comprises:
obtaining the smart indicator S according to a formula S=c₁A1+c₂A₂+c₃A₃+c₄log(R+1) of the smart indicator S; wherein in the formula, S indicates a smart indicator, A₁ indicates a safety index, c₁ indicates a weight of the safety index A₁, A₂ indicates an activity index, c₂ indicates a weight of the activity index A₂, A₃ indicates a linkage index, c₃ indicates a weight of the linkage index A₃, R indicates the number of devices, c₄ indicates a weight of the number R of devices,
$${\sum }_{k = 1}^{4} {c}_{k} = 1 ,$$
and k=1, 2, 3, 4.

8. The method according to claim 1, further comprising:
displaying the safety index, the activity index, the linkage index, and the smart indicator in at least one of the device.

9. An apparatus for calculating a smart indicator, comprising:
circuitry configured to acquire association information of smart indices;
circuitry configured to calculate corresponding smart indices respectively according to the acquired association information of the smart indices, the smart indices comprising: a safety index, an activity index, and a linkage index; and
circuitry configured to obtain the smart indicator by a weight calculation according to the smart indices and the number of devices.

10. The apparatus according to claim 9, further comprising:
circuitry configured to acquire usage information of a safety device corresponding to the safety index, login information of a smart home APP corresponding to the activity index, and configuration information of a smart scenario corresponding to the linkage index; and
circuitry configured to calculate a safety index according to the usage information of a safety device, calculating an activity index according to the login information of a smart home APP, and calculating a linkage index according to the configuration information of a smart scenario.

11. The apparatus according to claim 10, further comprising:
circuitry configured to acquire a total number n of types of safety devices corresponding to a safety index A₁, and the number Nᵢ of safety devices of a corresponding type i; and
circuitry configured to obtain the safety index A₁ according to a formula
$${A}_{1} = {\sum }_{i = 1}^{n} {a}_{i} * log ( {N}_{i} + 1 )$$
of the safety index A₁; wherein in the formula, A₁ indicates a safety index, n indicates the total number of types of the safety devices, i indicates the safety devices of the type i, aᵢ indicates a weight of the safety devices of the type i,
$${\sum }_{i = 1}^{n} {a}_{i} = 100 ,$$
and Nᵢ indicates the number of safety devices of the type i.

12. The apparatus according to claim 11, wherein when the number Nᵢ of safety devices of the type i is greater than a maximum number pₘₐₓ of the safety devices, a value of Nᵢ is set to Pₘₐₓ.

13. The apparatus according to claim 10, further comprising:
circuitry configured to acquire an activity cycle T corresponding to an activity index A₂, and login times Mⱼ of a user on the j^{th} day within the activity cycle T, and calculating a difference Qⱼ of days between the j^{th} day and a current date; and
circuitry configured to obtain the activity index A₂ according to a formula
$${A}_{2} = {\sum }_{j = 1}^{T} log ( {M}_{j} + 1 ) * ( T - {Q}_{j} )$$
of the activity index A₂; wherein in the formula, A₂ indicates an activity index, T indicates an activity cycle, Mⱼ indicates login times of a user on the j^{th} day within the activity cycle T, j indicates the j^{th} day within the activity cycle, and Qⱼ indicates a difference of days between the j^{th} day within the activity cycle T and a current date.

14. The apparatus according to claim 10, further comprising:
circuitry configured to acquire the number L of smart scenarios corresponding to a linkage index A₃; and
circuitry configured to obtain the linkage index A₃ according to a formula A₃=b*log(L+1) of the linkage index A₃; wherein in the formula, A₃ indicates a linkage index, b indicates a weight of the smart scenarios, and L indicates the number of smart scenarios.

15. The apparatus according to claim 9, further comprising:
circuitry configured to obtain the smart indicator S according to a formula S=c₁A1+c₂A₂+c₃A₃+c₄log(R+1) of the smart indicator S; wherein in the formula, S indicates a smart indicator, A₁ indicates a safety index, c₁ indicates a weight of the safety index A₁, A₂ indicates an activity index, c₂ indicates a weight of the activity index A₂, A₃ indicates a linkage index, c₃ indicates a weight of the linkage index A₃, R indicates the number of devices, c₄ indicates a weight of the number R of devices,
$${\sum }_{k = 1}^{4} {c}_{k} = 1 ,$$
and k=1, 2, 3, 4.

16. The apparatus according to claim 9, further comprising:
circuitry configured to display the safety index, the activity index, the linkage index, and the smart indicator.

17. A non-transitory computer-readable storage medium having stored therein instructions that, when executed by one or more processors of an apparatus, cause the apparatus to perform:
acquiring association information of smart indices; the association information including:
usage information of a safety device, login information of a smart home APP, configuration information of a smart scenario, and a number of devices;
calculating corresponding smart indices respectively according to the acquired association information of the smart indices; the smart indices including: a safety index, an activity index, and a linkage index; and
obtaining the smart indicator by a weight calculation according to the smart indices and the number of devices.

18. The non-transitory computer-readable storage medium according to claim 17, further storing instructions that, when executed by one or more processors of an apparatus, cause the apparatus to perform:
acquiring usage information of a safety device corresponding to the safety index, login information of a smart home APP corresponding to the activity index, and configuration information of a smart scenario corresponding to the linkage index; and
calculating the safety index according to the usage information of the safety device, calculating the activity index according to the login information of a smart home APP, and calculating the linkage index according to the configuration information of a smart scenario.

19. The non-transitory computer-readable storage medium according to claim 18, further storing instructions that, when executed by one or more processors of an apparatus, cause the apparatus to perform:
acquiring an activity cycle T corresponding to an activity index A₂, and login times Mⱼ of a user on the j^{th} day within the activity cycle T, and calculating a difference Qⱼ of days between the j^{th} day and a current date; and
obtaining the activity index A₂ according to a formula
$${A}_{2} = {\sum }_{j = 1}^{T} log ( {M}_{j} + 1 ) * ( T - {Q}_{j} )$$
of the activity index A₂; wherein in the formula, A₂ indicates an activity index, T indicates an activity cycle, Mⱼ indicates login times of a user on the j^{th} day within the activity cycle T, j indicates the j^{th} day within the activity cycle, and Qⱼ indicates a difference of days between the j^{th} day within the activity cycle T and a current date.

20. The non-transitory computer-readable storage medium according to claim 17, further storing instructions that, when executed by one or more processors of an apparatus, cause the apparatus to perform:
obtaining the smart indicator S according to a formula S=c₁A1+c₂A₂+c₃A₃+c₄log(R+1) of the smart indicator S; wherein in the formula, S indicates a smart indicator, A₁ indicates a safety index, c₁ indicates a weight of the safety index A₁, A₂ indicates an activity index, c₂ indicates a weight of the activity index A₂, A₃ indicates a linkage index, c₃ indicates a weight of the linkage index A₃, R indicates the number of devices, c₄ indicates a weight of the number R of devices,
$${\sum }_{k = 1}^{4} {c}_{k} = 1 ,$$
and k=1, 2, 3, 4.
